(19) United States
(12) Patent Application Publication
(10) Pub. No.: US 2025/0180069 A1
(43) Pub. Date: Jun. 5, 2025

(54) AXIAL ACTIVE MAGNETIC BEARING

(71) Applicant: INDUSTRIAL TECHNOLOGY RESEARCH INSTITUTE, Hsinchu (TW)

(72) Inventor: Shih-Ying CHIANG, Miaoli County (TW)

(21) Appl. No.: 18/746,114

(22) Filed: Jun. 18, 2024

(30) Foreign Application Priority Data
Dec. 1, 2023 (TW) 112146775

(51) Int. Cl. F16C 32/04

(52) U.S. Cl. CPC F16C 32/0465; F16C 32/0476

(57) ABSTRACT

An axial active magnetic bearing includes a rotating shaft, a magnetic yoke, a permanent magnet, a magnetic barrier structure and an electromagnetic coil. The rotating shaft includes a main shaft and a thrust plate; first and second air gaps with a projected area size having an error smaller than 5% are formed between the magnetic yoke and the thrust plate; the permanent magnet is provided on the magnetic yoke, and a third air gap is formed between the thrust plate and the permanent magnet; a permanent magnet magnetic flux is formed between the permanent magnet and the magnetic yoke; the magnetic barrier structure is provided on the magnetic yoke and positioned in the path of the permanent magnet magnetic flux, the permanent magnet magnetic flux is passed through the barrier structure, the first air gap and the third air gap; the electromagnetic coil is provided in a magnetic yoke chamber.

### CROSS REFERENCE TO RELATED APPLICATION

All related applications are incorporated by reference. The present application is based on, and claims priority from, Taiwan Application Serial Number 112146775, filed on Dec. 1, 2023, the disclosure of which is hereby incorporated by reference herein in its entirety.

### TECHNICAL FIELD

The present disclosure relates to a bearing technical field, and more particularly to an axial active magnetic bearing with linear control characteristics that has a magnetic barrier structure, decouples the control flux path from the permanent magnet flux path, can carry heavy loads in one direction, and satisfies the control current is proportional to the bearing capacity.

### BACKGROUND

Active magnetic bearings use electromagnets to control their output current to drive a magnetical spindle, causing the spindle to float. Compared with traditional mechanical bearings, active magnetic bearing systems provide non-contact support and are suitable for high-speed rotating machinery applications due to their low frictional resistance and without additional heat dissipation and lubrication. However, the loading capacity of the active magnetic bearing system is limited by the driving performance of the active magnetic bearing hardware. It is difficult to meet the use needs of heavy loads simply by only using electromagnets for control.

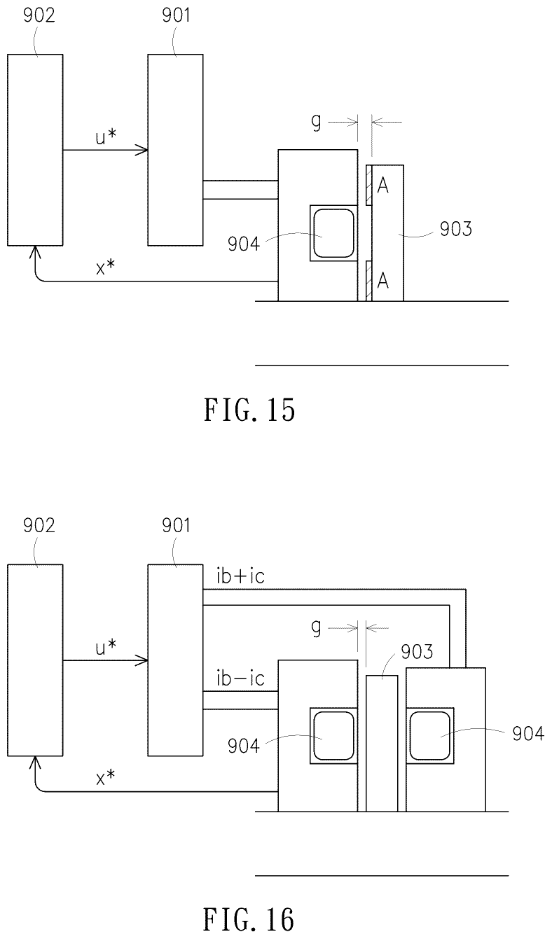

The traditional five-axis magnetic levitation rotating machine is composed of two sets of radial bearings, a set of axial bearings, a motor and a high-speed spindle with a thrust plate structure. The radial bearing is used to constrain the rotation center position of the spindle, the axial bearing is used to prevent the spindle from moving along the direction of the rotation axis, and the motor is used to provide shaft power. Among them, the axial bearing uses two pairs of coils, which are placed on both sides of the thrust plate. By adjusting the control current of the two sets of coils, the direction of the resultant magnetic force on the thrust plate is controlled. The position sensor is used to detect the axial position of the thrust plate or spindle. When the position deviates to one side and the spindle is wanted to move to the other side, the driver needs to be controlled to increase the current of the coil on the other side and reduce the current on this side at the same time. The coil current on this side causes the resultant magnetic force on the thrust plate to increase toward the other side. Referring to FIG. 15, there are a drive circuit 901, a control circuit 902 and a thrust plate 903, where the control circuit 902 receives the feedback signal x*, and outputs the control command u*, used to drive the drive circuit 901. About how the electromagnet and the thrust plate work, if only one side of the axial bearing is considered, its air gap length to thrust disc 903 is g, the number of coil turns N, the control circuit I, the air gap cross-section is A. Under the constraint that its main magnetic path does not reach magnetic saturation, its magnetic force can be expressed as follows:

$${F}_{mag} = \frac{{μ}_{0} {AN}^{2}}{2} {( \frac{i}{g} )}^{2}$$

It is obvious that the magnetic force is proportional to the square of the control current, and inversely proportional to the square of the air gap distance, which needs to adopt a non-linear control technology to design a controller to achieve the control goal. Referring to FIG. 16, it has a drive circuit 901, a control circuit 902 and a thrust plate 903, where the control circuit 902 receives the feedback signal x*, and outputs the control command u*, adapted to drive the drive circuit 901. Assuming that under the condition that the air gap is far larger than the thrust plate displacement, the same coils 904 are placed on the two sides of the thrust plate 903, both the air gaps at the two sides are g, and the current flowing through the two coils 904 is caused to be decomposed into a bias current i_{b} and a control current i_{c}. With a fixed bias current i_{b}, the magnetic resultant force experienced by the thrust plate 903 is only linearly related to the control current i_{c} (see the following equation). The system can control the axial displacement with a linear controller.

$$\sum {F}_{mag} = \frac{2 {μ}_{0} {AN}^{2} {i}_{b}}{{g}^{2}} {i}_{c}$$

In short, in order to allow the traditional axial active magnetic bearing to have the feature of linear control, it needs to specially design a suitable air gap and a pair of electromagnetic coils, and a fixed bias current i_{b} and a differential control current i_{c} must be applied to the drive circuit 901. This axial bearing structure requires precise adjustment of the air gap positions of the two pairs of electromagnetic coils to ensure that the lengths of the two air gaps are equal, which requires very high assembly quality. In addition, since the drive current is composed of a control current and a bias current, an excessive bias current will reduce the available control current range.

The generally adopted drive circuit of the active magnetic bearing consists of a pair of switch elements and a pair of diodes, between which are connected with a coil when the switch element is short, the current flows into the circuit from a voltage source, and when the switch element is open, its current will flow back to the voltage source from the diode due to flywheel effect; the switch element is adopted with a pulsed width modulation (PWM), which adjusts the switching duration ratio based on the duty cycle, and can then control the coil current. This circuit has the characteristics of current recycling, being simple, highly efficient, and can be broadly used. However, since this control circuit uses diodes to control the current flow, it is only suitable for single-directional coil current applications.

Compared with radial bearings, axial bearings have a complex structure and a large number of assembly and matching components. Their placement is in the middle of the main shaft, which is not conducive to reducing the size of the thrust plate and subsequent adjustment and maintenance operations.

In view of this, in actual commercial applications, a magnetic bearing system architecture with a rear thrust plate has been developed. The thrust plate is placed at the end of the main shaft. In addition to shortening the length of the main shaft and the size of the thrust plate, the thrust plate can also be combined with the main shaft. The main shaft is installed separately to reduce the operating costs of maintenance such as thrust plate clearance adjustment.

In order to further reduce the complexity of the axial bearing and reduce the size of the thrust plate, permanent magnets are placed between the radial bearing and the axial bearing in commercial applications to provide the axial bearing air gap to generate a uniform bias magnetic field, and an electromagnet coil is placed on the outer edge of the thrust plate, and its control current can simultaneously increase/offset the magnetic field in the air gaps on both sides, thereby controlling the size and direction of the magnetic resultant force of the thrust plate. It can replace the traditional magnetic bearing design scheme and only use a single coil achieves the goal of controlling the axial displacement of the main shaft.

However, this design also induces the problem that the permanent magnet bias magnetic field needs to pass through the radial bearing, and the magnetic fields of the axial bearing and the radial bearing are locally coupled, causing the controller design to be more difficult; in addition, using a single coil means that the coil current needs to flow in both directions, which increases the cost of the gate driver.

Many rotating machines work in areas with large axial loads, such as blowers, ORC axial flow generators, flywheel energy storage systems, etc.; in the aforementioned axial bearing design scheme, when the rotating machinery system is under low axial load, axial magnetic bearings operate under light load conditions. When the rotating machine operates under rated conditions, the axial magnetic bearing operates under heavy load. In addition to energy loss, the axial bearing is also susceptible to the impact of extreme working conditions and loss of control.

In order to solve this problem, a single-side axial bearing system is designed to solve the application scenario of large axial load. This design uses permanent magnets to support the axial force of the rotating machine operating. An electromagnet coil is installed on the other side of the permanent magnet to adjust the magnitude and direction of the magnetic resultant force to achieve the control purpose of axial displacement. Using a single-side axial bearing needs to break through the inherent limitations of nonlinear control in control technology to have the possibility of practical application.

There have been many patent documents laying out axial permanent magnet offset active magnetic bearings, but most of them focus on the axial/radial hybrid bearing topological structure. The following is only analyses and discussions of well-known patents for axial permanent magnet bias bearings with single coil control or unidirectional output.

For example, a common U.S. patent (Patent No. U.S. Pat. No. 8,102,088B2), titled “GENERATING ELECTROMAGNETIC FORCES WITH FLUX FEEDBACK CONTROL” (GENERATING ELECTROMAGNETIC FORCES WITH FLUX FEEDBACK CONTROL), designs a permanent magnet offset axial bearing that uses two sets of permanent magnets to create a bias magnetic flux that two directions are opposite along a specific bearing structure path. The two magnetic fluxes converge on the thrust plate, so that the air gap of the thrust plate has a permanent magnet bias magnetic flux. Providing an electromagnetic coil and passing a control current can increase (or decrease) the air gap in the thrust plate and decrease (or increase) the other air gap, thereby changing the force on the thrust plate. A magnetic field sensor is placed at the air gap position and the differential magnetic field is controlled by directly measuring the magnetic flux to achieve the control purpose. However, this conventional technology requires installing a magnetic field sensor in the air gap structure to achieve the goal of linear control, which is difficult to achieve in practice. In addition, the electromagnetic coil needs to be supplied with bidirectional current to achieve the goal of controlling the axial position, which is also one of the shortcomings of the conventional bearing design.

Another example is another conventional U.S. patent (Patent No. U.S. Pat. No. 8,482,174B2), titled “ELECTROMAGNETIC ACTUATOR”. This conventional patent provides a permanent magnet between the axial bearing and the radial bearing. Between them, the permanent magnetic path flows through the axial bearing air gap and the radial bearing air gap. A control current is passed through the electromagnetic coil to generate a control magnetic flux, which increases (or decreases) the magnetic flux in one air gap and simultaneously decreases (or increases) the magnetic flux in another air gap. By adjusting the size and direction of the control current, the purpose of controlling the thrust plate is achieved. This conventional patent uses a single electromagnetic coil for axial control, but bidirectional current is still a necessary condition for its control. In addition, in this conventional patent, in order to achieve the purpose of sharing the axial radial permanent magnet magnetic flux, the permanent magnet magnetic flux has a long path and high coupling with the axial magnetic flux, which is its main shortcoming.

Another example is another commonly known US patent (Patent No. U.S. Pat. No. 11,005,336B1), titled “MAGNETIC BEARING ASSEMBLY FOR ROTATING MACHINERY”, which uses four sets of single-side axial bearings. The actuator cooperates with two sets of passive radial bearings to achieve the goal of five-axis suspension control. However, this conventional patent does not solve the problem of nonlinear control of single-side axial bearings, and does not propose a method to reduce the manufacturing difficulty of passive radial bearings, making it difficult for practical commercial application.

For example, another conventional Chinese patent (patent number CN106286590B), titled “A permanent magnet biased axial magnetic levitation bearing and centrifugal compressor”, is based on the aforementioned “Electromagnetic actuator”. The conventional patent changes the original radial air gap to the axial thrust plate, so that there are paired two air gaps and independent one air gap on both sides of the thrust plate. The independent air gap provides additional axial force support, making the axial bearing have initial magnetic bias force.

However, the design of the permanent magnet magnetic flux in this conventional patent must pass through three air gaps. The conventional patent does not specify how to ensure that the permanent magnetic flux of the air gap is equal and opposite to that of the air gap, and the overlap between the permanent magnetic flux path and the control magnetic flux path is high. It can be expected that the magnetic flux coupling effect will be significant.

Based on this, how to develop an “axial magnetic bearing” that decouples the control flux path and the permanent magnet flux path, can carry heavy loads in one direction, and satisfies the control current is proportional to the bearing capacity, is an urgent issue that needs to be solved by people in related technical fields.

### SUMMARY

In an embodiment, the present disclosure proposes an axial active magnetic bearing, fixed to a structural object and symmetric to a rotation axis, the axial active magnetic bearing including: a rotating shaft, including a main shaft and a thrust plate, the main shaft coaxial with the rotation axis, and the thrust plate concentrically arranged on the main shaft; a magnetic yoke, including a first side and a second side opposite to each other, the first side and the second side respectively provided on two axial sides of the thrust plate and not contacting the thrust plate, a corresponding end of the first side and the second side having a chamber, the chamber positioned on a radial outside of the thrust plate, the first side having a first air gap surface adjacent to the chamber, the second side having a second air gap adjacent to the chamber, a first air gap formed between the first air gap surface and the thrust plate, a second air gap formed between the air gap surface and the thrust plate, and the error in a projected area size of the first air gap and the second air gap along the direction of the rotation axis less than 5%; a permanent magnet, provided on a surface of the magnetic yoke facing the thrust plate relative to the main shaft, the permanent magnet not contacting the thrust plate, a third air gap formed between the thrust plate and the permanent magnet, and a permanent magnet magnetic flux formed between the permanent magnet and the magnetic yoke; a magnetic barrier structure, provided on the first side and positioned between the permanent magnet and the first air gap surface, the first side having a first distance of cross-section area parallel to the rotation axis, the magnetic barrier structure having a second distance of cross-section area parallel to the rotation axis, the second distance of cross-section area smaller than the first distance of cross-section area, the magnetic barrier structure positioned in a path of the permanent magnet magnetic flux, and permanent magnet magnetic flux passed through the magnetic barrier structure, the first air gap and the third air gap; and an electromagnetic coil, provided in the chamber and not contacting the thrust plate, a control magnetic flux formed between the thrust plate and the magnetic yoke after control current flows in the electromagnet coil, and the control magnetic flux passed through the first air gap and the second air gap.

### BRIEF DESCRIPTION OF THE DRA WINGS

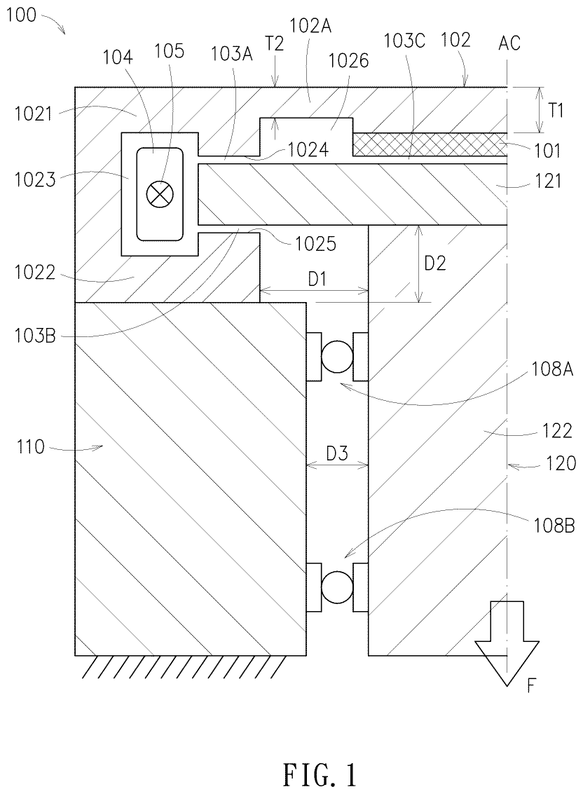

FIG. 1 is a schematic view of an embodiment of the present disclosure;

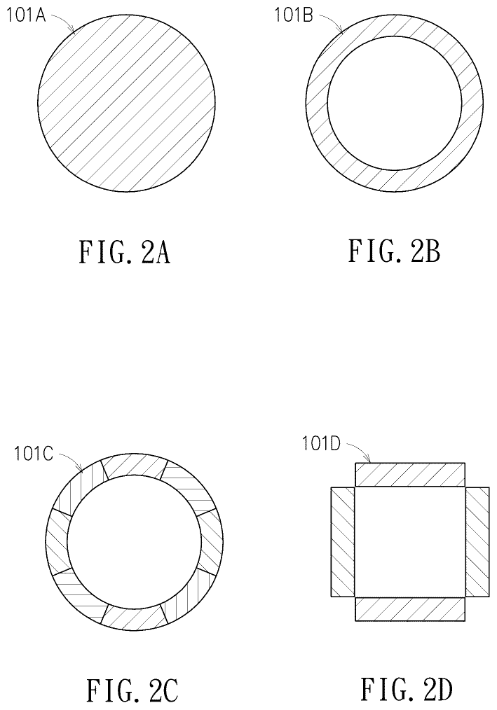

FIGS. 2A to 2D respectively a schematic view of a different implementation type structure of a permanent magnet of the present disclosure;

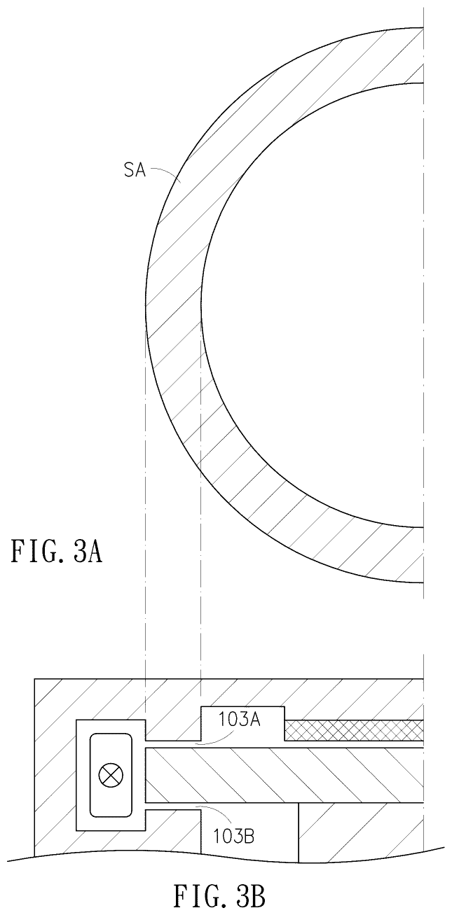

FIGS. 3A and 3B respectively a schematic view of the projected area of a first air gap and a second air gap of the embodiment of FIG. 1;

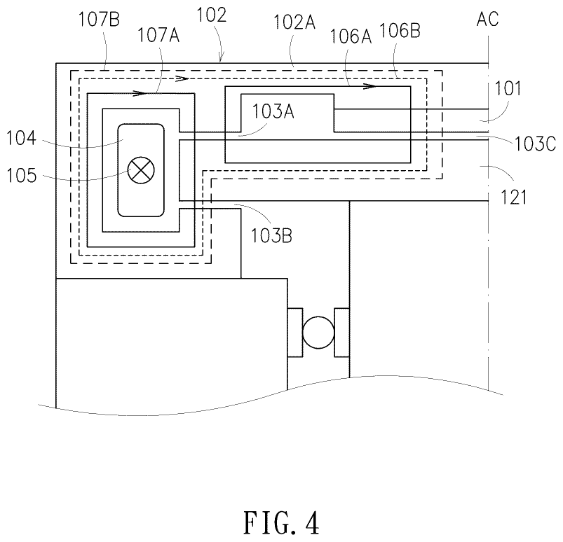

FIG. 4 is a schematic view of a magnetic flux path of the embodiment of FIG. 1;

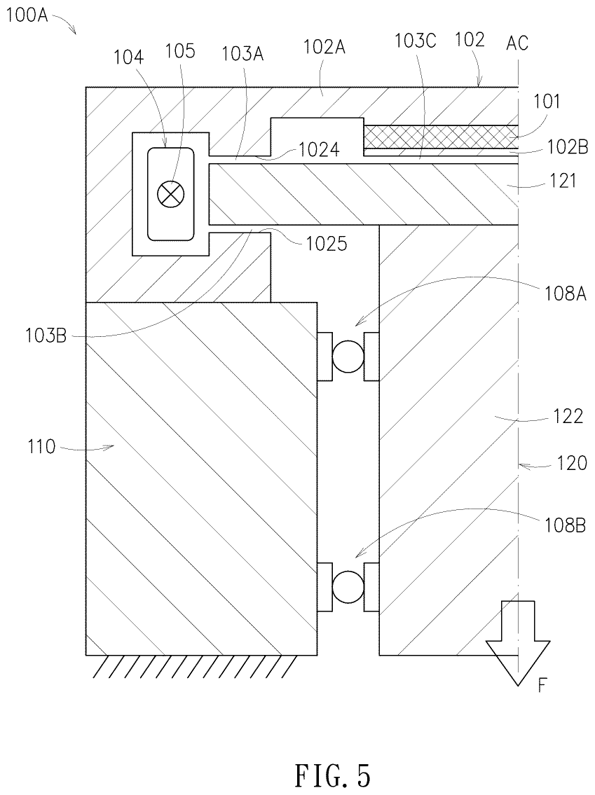

FIG. 5 is a schematic view of a structure of another embodiment of the present disclosure;

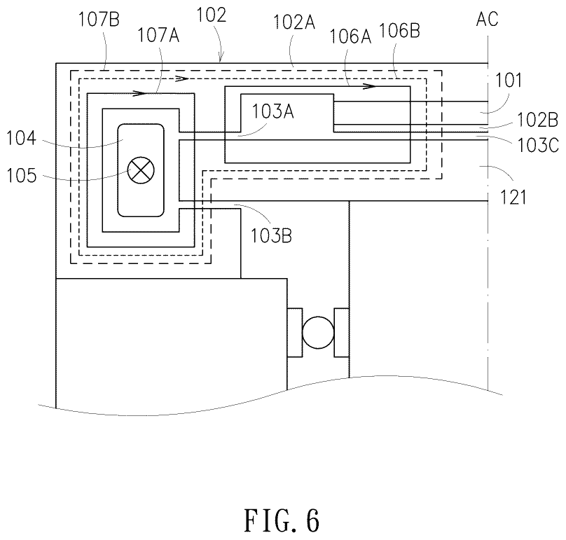

FIG. 6 is a schematic view of a magnetic flux path of the embodiment of FIG. 1;

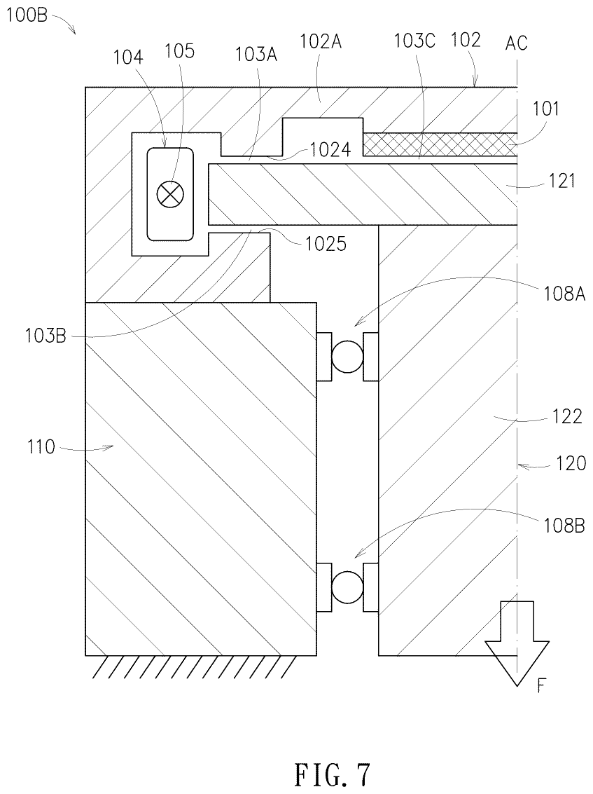

FIG. 7 is a schematic view of a structure of another embodiment of the present disclosure;

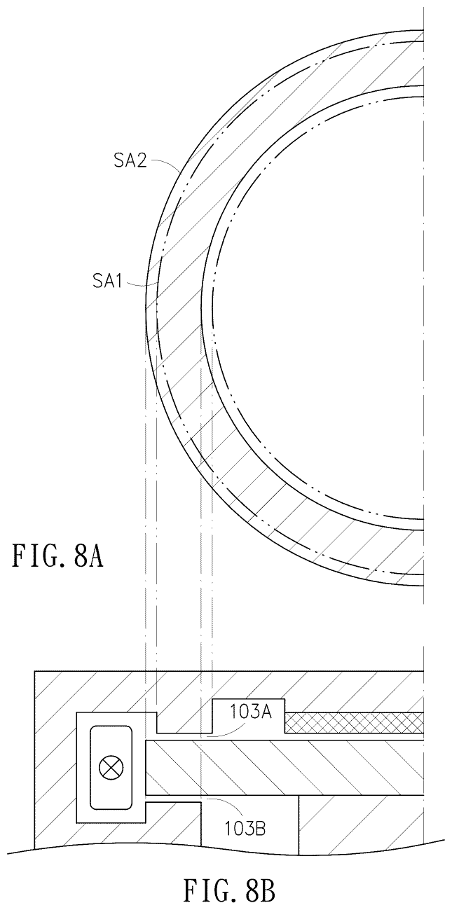

FIGS. 8A and 8B respectively are a schematic view of the projected areas of a first air gap and a second air gap of the embodiment of FIG. 7;

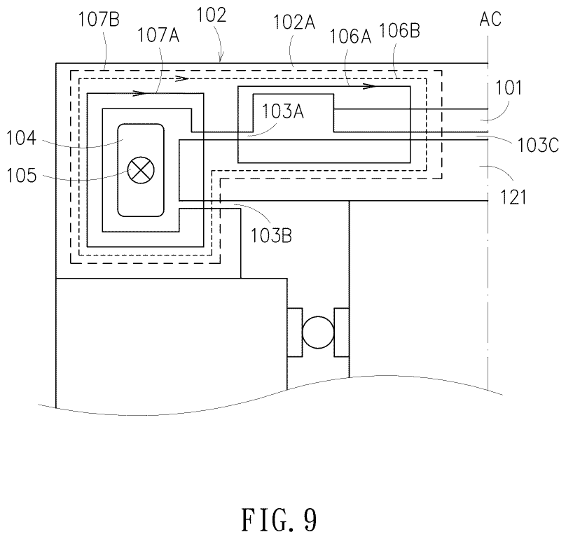

FIG. 9 is a schematic view of a magnetic flux path of the embodiment of FIG. 7;

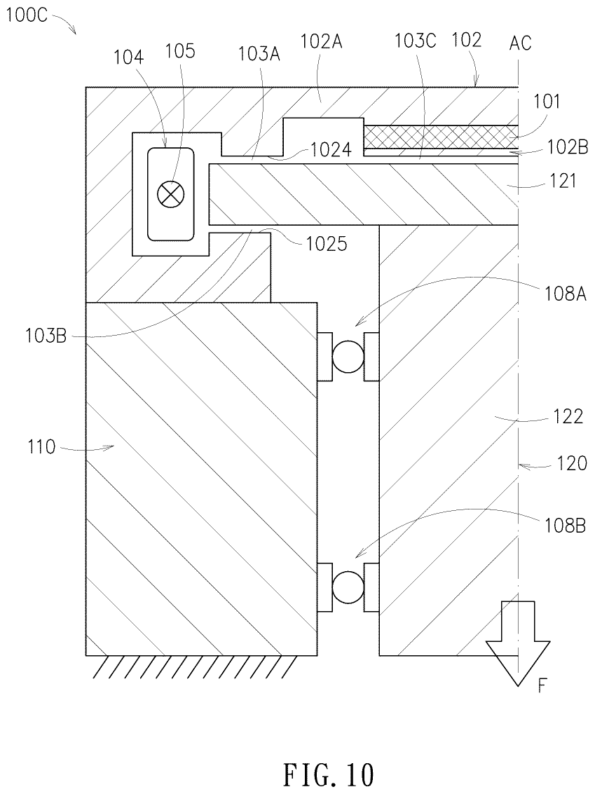

FIG. 10 is a schematic view of a structure of still another embodiment of the present disclosure;

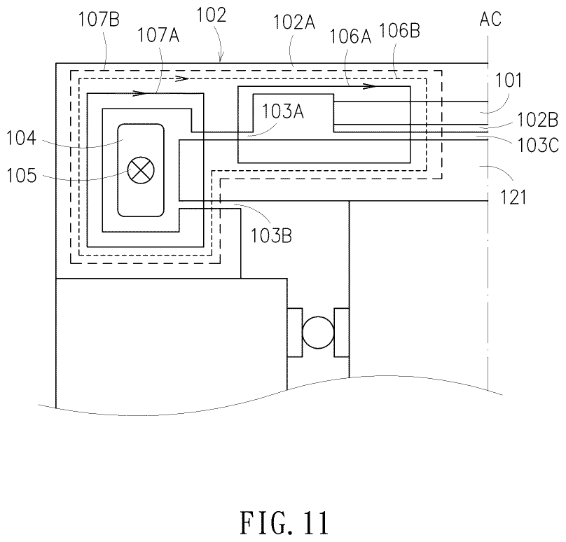

FIG. 11 is a schematic view of a magnetic flux path of the embodiment of the present disclosure;

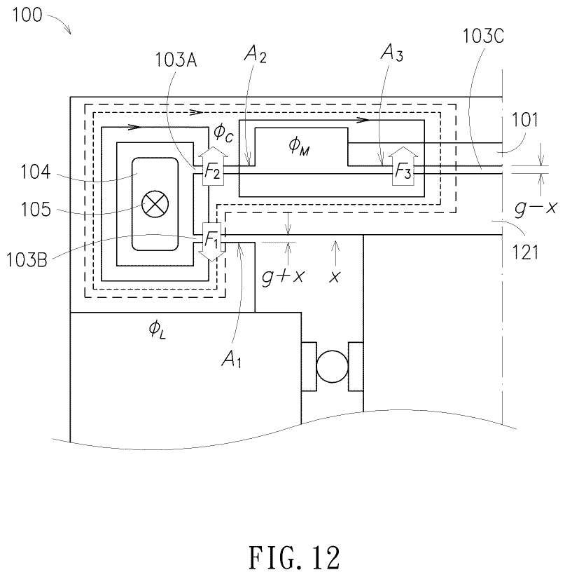

FIG. 12 is a schematic view of the distance, displacement and area parameter of a main magnetic flux path and an air gap of the present disclosure;

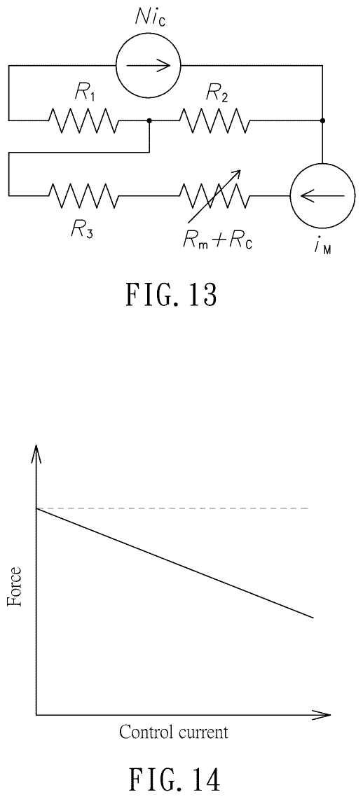

FIG. 13 is a schematic view of a magnetic circuit of the present disclosure;

FIG. 14 is a relationship diagram of thrust plate force and control current of the present disclosure;

FIG. 15 is a schematic view of the structure of the air gap and flux cross-section area of a conventional axial bearing and disc; and

FIG. 16 is a schematic view of the structure of a conventional differential current controlling an axial bearing disc.

### DETAILED DESCRIPTION

Referring to FIG. 1, an axial active magnetic bearing 100 of the present disclosure, in an embodiment, can be broadly used in applications where unidirectional axial loads are supported. FIG. 1 only shows a half side symmetrical to a rotation axis AC.

Referring to the embodiment shown in FIG. 1, the axial active magnetic bearing 100 of the present disclosure includes a permanent magnet 101, a magnetic yoke 102, a rotating shaft 120 and an electromagnetic coil 104.

The rotating shaft 120 is composed of a thrust plate 121 and a main shaft 122. The main shaft 122 is coaxial with the rotation axis AC, and the thrust plate 121 is concentrically arranged at one axial end of the main shaft 122.

The axial active magnetic bearing 100 is fixed to a structural object 110, and symmetric to the rotation axis AC. The structural object 110 may be made of non-magnetic material. The axial active magnetic bearing 100 takes the magnetic yoke 102 as a main body. The magnetic yoke 102 does not need to be integrated into one body, and may be formed by combining a plurality of magnetic components together.

The permanent magnet 101 is provided on a surface of the magnetic yoke 102 facing the thrust plate 121, and the permanent magnet 101 is not in contact with the thrust plate 121. The magnetizing direction of the permanent magnet 101 is not limited to the direction along the rotation axis AC, and can be fixed to the magnetic yoke 102 by means of bonding or by means of clamp locking.

Referring to FIGS. 2A to 2D, the permanent magnet 101 is shaped according to the actual usage, for example, the circular disc-shaped permanent magnet 101A as shown in FIG. 2A, or the circular ring-shaped permanent magnet 101B as shown in FIG. 2B, or the permanent magnet formed by surrounding it with a plurality of fan-shaped permanent magnets 101C as shown in FIG. 2C, or the permanent magnet formed by surround it with a plurality of rectangular permanent magnets 101D as shown in FIG. 2D.

Referring to FIG. 1 again, the rotating shaft 120 is symmetric to the rotation axis AC, and the rotating shaft 120 bears a unidirectional load F. radial bearings 108A and 108B are provided between the rotating shaft 120 and the structural object 110, allowing the rotating shaft 120 to take the radial bearings 108A and 108B and the structural object 110 to maintain the radial relative position.

It must be explained that the present disclosure is not limited to provide the thrust plate 121 on an axial end of the main shaft 122; if the permanent magnet 101 is a ring-shaped body, the axial active magnetic bearing 100 may be provided between the two radial bearings 108A and 108B.

The main shaft 122 and the magnetic yoke 102 are separated a distance D1; since the main shaft 122 is a magnetic body, the magnetic flux leakage can be prevented through the first distance D1. The dimension of the first distance D1 is designed depending on actual needs, for example, the material of the main shaft 122, the size of the overall axial active magnetic bearing 100, etc. can be used to ensure that the main shaft 122 and the magnetic yoke 102 do not contact each other.

In addition, if the structural object 110 is a magnetic body, it needs to be kept a second distance D2 with the thrust plate 121 to prevent magnetic flux leakage. The dimension of the second distance D2 is design depending on the actual needs, for example, the material of the main shaft 122, the size of the overall axial active magnetic bearing 100, etc. can be used to ensure that the structural object 110 and the thrust plate 121 do not contact each other.

Alternatively, if the structural object 110 and the main shaft 122 are both magnetic bodies, then the structural object 110 and the main shaft 122 must maintain a third distance D3 to avoid magnetic flux leakage. The dimension of the third distance D3 is designed depending on actual needs, for example, the material of the main shaft 122, the size of the overall axial active magnetic bearing 100, etc. can be used to ensure that the structural object 110 and the main shaft 122 do not contact each other.

In other words, when the structural object 110 and the main shaft 122 respectively are a magnetic body, the distance between the structural object 110, the main shaft 122, the magnetic yoke 102 and the thrust plate 121 must be paid in attention in design.

Referring to FIG. 1 again, the magnetic yoke 102 includes a first side 1021 and a second side 1022 opposite to each other, and the first side 1021 and the second side 1022 are respectively provided on the two axial sides of the thrust plate 121 and does not contact the thrust plate 121.

A corresponding end of the first side 1021 and the second side 1022 has a chamber 1023 positioned on the radial outer side of the thrust plate 121. The position of the first side 1021 adjacent to the chamber 1023 has a first air gap surface 1024, and the position of the second side 1022 adjacent the chamber 1023 has a second air gap surface 1025, where a first air gap 103A is formed between the first air gap surface 1024 and the thrust plate 121, and a second air gap 103B is formed between the second air gap surface 1025 and the thrust plate 121.

The error in the projected area size of the first air gap 103A and the second air gap 103B along the direction of the rotation axis AC is less than 5%, and the geometric shape of the projected area is not limited.

Referring to FIGS. 3A and 3B, the geometric shapes of the projected areas of the first air gap 103A and the second air gap 103B are both in the shape of a semi-circular ring. If they are symmetrical about the rotation axis AC, a circular ring-shaped air gap can be formed. The projected areas SA of the first air gap 103A and the second air gap 103B along the direction of the rotation axis AC are equal in size, and the projection range of the first air gap 103A and the projection range of the second air gap 103B completely overlap.

Referring to FIG. 1 again, the electromagnetic coil 104 is provided on the outer edge of the thrust plate 121, where the electromagnetic coil 104 can input the control current 105, and its current direction is not limited.

Referring to FIGS. 1 and 4, the thrust plate 121 and the permanent magnet 101 do not contact each other, and a third air gap 103C is formed between the thrust plate 121 and the permanent magnet 101. A permanent magnet magnetic flux 106A is formed among the thrust plate 121, the permanent magnet 101 and the magnetic yoke 102.

A magnetic barrier structure 102A is provided on the first side 1021 of the magnetic yoke 102 and positioned between the permanent magnet 101 and the first air gap surface 1024, and the magnetic barrier structure 102A is positioned in the path of the permanent magnet magnetic flux 106A, and the permanent magnet magnetic flux 106A passes through the magnetic barrier 102A, the first air gap 103A and the third air gap 103C.

The function of the magnetic barrier structure 102A is to limit the permanent magnet magnetic flux 106A, the magnetic barrier structure 102A can be achieved by reducing a magnetic flux cross-section area, or the magnetic barrier structure 102A may be made of materials with a different magnetic permeability coefficient, for example, using materials with a low magnetic permeability coefficient, thereby controlling magnetic flux. Taking ferrite as an example, its magnetic permeability coefficient is 800 μH/m, and the magnetic permeability coefficient of electrical steel is 4000 μH/m; the magnetic permeability of ferrite is one-fifth that of electrical steel, and thus, ferrite is superior to electrical steel in the magnetic flux limiting effect.

For example, in the embodiment of FIG. 1, the first side 1021 has a first distance of cross-section area T1, and the surface of the magnetic yoke 102 facing the thrust plate 121 is provided with a groove 1026 to form the magnetic barrier structure 102A, where the thickness of the magnetic barrier structure 102A is a second distance of cross-section area T2, and the second distance of cross-section area T2 is smaller than the first distance of cross-section area T1, namely, the magnetic flux cross-section area of the magnetic yoke 102 at the magnetic barrier structure 102A is smaller.

When the permanent magnet magnetic flux 106A flows through the magnetic barrier structure 102A, the magnetic flux of the permanent magnet magnetic flux 106A can be limited.

However, the manner of reducing magnetic flux cross-section area is not limited to that shown in FIG. 1, and can be designed according to actual needs.

Referring to FIGS. 1 and 4, after the control current 105 flows in the electromagnetic coil 104, a control magnetic flux 107A will be formed between the thrust plate 121 and the magnetic yoke 102. The control magnetic flux 107A is passed through the first air gap 103A and the second air gap 103B.

Referring to FIG. 4, it is worth to explain that under an ideal situation, the magnetic flux of the permanent magnet magnetic flux 106A and the control magnetic flux 107A should be 100%. However, due to various factors such as structure and material, a permanent magnet magnetic leakage flux 106B and a control magnetic leakage flux 107B will inevitably occur.

Both the paths of the permanent magnet magnetic leakage circuit 106B and the control magnetic leakage circuit 107B pass through the magnetic barrier structure 102A, the second air gap 103B and the third air gap 103C. Due to the physical limit of the magnetic barrier structure 102A, the magnetic leakage flux can be reduced to be far smaller than the permanent magnet magnetic flux 106A, even to the extent that it can be ignored. The permanent magnet magnetic flux 106A and the control magnetic flux 107A are only coupled at the first air gap 103A, and the value of the permanent magnet magnetic flux 106A can be regarded as a constant and is independent of the control current 105.

Referring to the embodiment shown in FIG. 5, the structure of an axial active magnetic bearing 100A and the structure of the axial active magnetic bearing 100 shown in FIG. 1 are almost the same; the axial active magnetic bearing 100A includes a permanent magnet 101, a magnetic yoke 102, a rotating shaft 120 and an electromagnetic coil 104. The axial active magnetic bearing 100A is fixed to a structural object 110. The rotating shaft 120 is constituted by the thrust plate 121 and the main shaft 122. Radial bearings 108A and 108B are provided between the rotating shaft 120 and the structural object 110.

The main difference between the embodiment of FIG. 5 and the embodiment of FIG. 1 is that a magnetic plate 102B with magnetic permeability is provided on the surface of the permanent magnet 101 of the embodiment of FIG. 5 facing the thrust plate 121.

Referring to FIGS. 5 and 6, a first air gap 103A is formed between the first air gap surface 1024 and the thrust plate 121, a second air gap 103B is formed between the second air gap surface 1025 and the thrust plate 121, and a third air gap 103C is formed between the thrust plate 121 and the magnetic plate 102B. The projected areas SA of the first air gap 103A and the second air gap 103B along the direction of the rotation axis AC are equal in size, and the projected range of the first air gap 103A and the projected range of the second air gap 103B are all overlapped, as shown in FIGS. 3A and 3B. However, due to actual manufacturing tolerances, the manufacturing error of the projected area SA can be less than 5%.

A magnetic barrier structure 102A is provided on the first side 1021 of the magnetic yoke 102. A permanent magnet magnetic flux 106A is provided among the thrust plate 121, the permanent magnet 101 and the magnetic yoke 102.

After the control current 105 flows in the electromagnetic coil 104, a control magnetic flux 107A will be formed between the thrust plate 121 and the magnetic yoke 102. The control magnetic flux 107A is passed through the first air gap 103A and the second air gap 103B. The magnetic flux of the third air gap 103C is allowed to be uniformly distributed through the magnetic plate 102B.

Both the passes of the permanent magnet magnetic leakage flux 106B and the control magnetic leakage circuit 107B are passed through the magnetic barrier structure 102A, the second air gap 103B and the third air gap 103C. Due to the physical limit of the magnetic barrier structure 102A, the magnetic leakage flux can be reduced to be far smaller than the permanent magnet magnetic flux 106A, even to the extent that it can be ignored.

Referring to the embodiment shown in FIG. 7, the structure of an axial active magnetic bearing 100B and the structure of the axial active magnetic bearing 100 shown in FIG. 1 are almost the same; the axial active magnetic bearing 100B includes a permanent magnet 101, a magnetic yoke 102, a rotating shaft 120 and an electromagnetic coil 104. The axial active magnetic bearing 100B is fixed to a structural object 110. The rotating shaft 120 is constituted by the thrust plate 121 and the main shaft 122. Radial bearings 108A and 108B are provided between the rotating shaft 120 and the structural object 110.

The first side 1021 has a first air gap surface 1024 adjacent to the chamber 1023, and the second side 1022 has a second air gap surface 1025 adjacent to the chamber 1023.

The main difference between the embodiment of FIG. 7 and the embodiment of FIG. 1 is that in the embodiment of FIG. 7, the projected positions of the first air gap surface 1024 and the second air gap surface 1025 are dislocated along the direction of the rotation axis AC.

Referring to FIGS. 8A and 8B, the geometric shapes of the projected areas of the first air gap 103A and the second air gap 103B are both in the shape of a semi-circular ring. If they are symmetrical about the rotation axis AC, a circular ring-shaped air gap can be formed. The projected areas SA of the first air gap 103A and the second air gap 103B along the direction of the rotation axis AC are equal in size, and the projection range of the first air gap 103A and the projection range of the second air gap 103B partially overlap.

Referring to FIGS. 7 and 9, a first air gap 103A is formed between the first air gap surface 1024 and the thrust plate 121, a second air gap 103B is formed between the second air gap surface 1025 and the thrust plate 121, and a third air gap 103C is formed between the thrust plate 121 and the permanent magnet 101.

A magnetic barrier structure 102A is provided on the first side 1021 of the magnetic yoke 102. A permanent magnet magnetic flux 106A is provided among the thrust plate 121, the permanent magnet 101 and the magnetic yoke 102.

After the control current 105 flows in the electromagnetic coil 104, a control magnetic flux 107A will be formed between the thrust plate 121 and the magnetic yoke 102. The control magnetic flux 107A is passed through the first air gap 103A and the second air gap 103B.

Both the paths of the permanent magnet magnetic leakage flux 106B and the control magnetic leakage flux 107B pass through the magnetic barrier structure 102A, the second air gap 103B and the third air gap 103C. Due to the physical limit of the magnetic barrier structure 102A, the magnetic leakage flux can be reduced to be far smaller than permanent magnet magnetic flux 106A, even to the extent that it can be ignored.

Referring to the embodiment shown in FIG. 10, the structure of an axial active magnetic bearing 100C and the structure of the axial active magnetic bearing 100B shown in FIG. 7 are almost the same; the axial active magnetic bearing 100C includes a permanent magnet 101, a magnetic yoke 102, a rotating shaft 120 and an electromagnetic coil 104. The axial active magnetic bearing 100C is fixed to a structural object 110. The rotating shaft 120 is constituted by the thrust plate 121 and the main shaft 122. Radial bearings 108A and 108B are provided between the rotating shaft 120 and the structural object 110.

The main difference between the embodiment of FIG. 10 and the embodiment of FIG. 7 is that a magnetic plate 102B with magnetic permeability is provided on the surface of the permanent magnet 101 of the embodiment of FIG. 10 facing the thrust plate 121.

Referring to FIGS. 10 and 11, a first air gap 103A is formed between the first air gap surface 1024 and the thrust plate 121, a second air gap 103B is formed between the second air gap surface 1025 and the thrust plate 121, and a third air gap 103C is formed between the thrust plate 121 and the magnetic plate 102B. The projected area SA1 of the first air gap 103A and the projected area SA2 of the second air gap 103B along the direction of the rotation axis AC are equal in size, and the projected range of the first air gap 103A and the projected range of the second air gap 103B are partially overlapped, as shown in FIGS. 8A and 8B. However, due to actual manufacturing tolerances, the error of the projected area SA1. SA2 can be less than 5%.

The first side 1021 of the magnetic yoke 102 is provided with a magnetic barrier structure 102A. A permanent magnet magnetic flux 106A is formed among the thrust plate 121, the permanent magnet 101 and the magnetic yoke 102.

After the control current 105 flows in the electromagnetic coil 104, a control magnetic flux 107A will be formed between the thrust plate 121 and the magnetic yoke 102. The control magnetic flux 107A is passed through the first air gap 103A and the second air gap 103B. The magnetic flux of the third air gap 103C is allowed to be uniformly distributed through the magnetic plate 102B.

Both the paths of the permanent magnet magnetic leakage flux 106B and the control magnetic leakage flux 107B pass through the magnetic barrier structure 102A, the second air gap 103B and the third air gap 103C. Due to the physical limit of the magnetic barrier structure 102A, the magnetic leakage flux can be reduced to be far smaller than the permanent magnet magnetic flux 106A, even to the extent that it can be ignored.

The different types of permanent magnets 101A to 101D shown in FIGS. 2A to 2D are suitable for the axial active magnetic bearings 100A, 100B, and 100C of FIGS. 5, 7, and 10.

When the thrust plate 121 is axially moved, the first air gap 103A, the second air gap 103B and the third air gap 103C will be changed according to displacement. As for the magnetic fluxes shown in FIGS. 4, 6, 9 and 11, the present disclosure partially couples the magnetic field of the permanent magnet 101 with the magnetic field path of the electromagnetic coil 104, so that the thrust plate 121 only has the first air gap 103A on one side. The magnetic flux passing through the permanent magnet 101 and the magnetic flux generated by the electromagnetic coil 104 pass through the first air gap 103A at the same time, and the two magnetic fluxes have opposite directions.

The present disclosure designs a magnetic saturation region in the magnetic field path of the permanent magnet 101 to limit the magnetic flux of the permanent magnet 101 through the third air gap 103C so that the magnetic flux does not change with the control current 105 of the electromagnetic coil 104.

As for the operating principle to achieve the above-mentioned effect of the present disclosure, including the aforementioned as shown in FIG. 4, due to the physical limitations of the magnetic barrier structure 102A, the leakage magnetic flux can be reduced to much less than the magnetic flux of the permanent magnet magnetic flux 106A, or even to the extent that can be ignored; it can be verified through the following mathematical calculations, derivation formulas and explanations.

Referring to FIG. 12, supposed that the magnetic leakage only exists inside the structure of the axial active magnetic bearing 100, the magnetic leakage paths of the permanent magnet 101 and the electromagnetic coil 104 are the same. The air gap areas of the first air gap 103A, the second air gap 103B and the third air gap 103C respectively are A₁, A₂, A₃. Define the control current magnetic flux ϕ_{C} of the electromagnetic coil 104, the bias magnetic flux ϕ_{M} and the leakage magnetic flux ϕ_{L} of the permanent magnet 101. The magnetic forces F₁, F₂, F₃ generated from first air gap 103A, the second air gap 103B, the third air gap 103C can be respectively expressed as follows:

$${F}_{1} = \frac{1}{2 {μ}_{0} {A}_{1}} {( {ϕ}_{C} + {ϕ}_{L} )}^{2} , {F}_{2} = \frac{1}{2 {μ}_{0} {A}_{2}} {( {ϕ}_{M} + {ϕ}_{C} )}^{2} , {F}_{3} = \frac{1}{2 {μ}_{0} {A}_{3}} {( {ϕ}_{M} + {ϕ}_{L} )}^{2}$$

The air gap area is simplified to the dimensionless parameters 103C ucture of the axial act

$$\frac{{A}_{1}}{{A}_{2}} = λ ‵ \frac{{A}_{1}}{{A}_{3}} = {λ}^{′}$$

Then the resultant force on the thrust plate 121 can be expressed by the following equation:

$$\sum F = \frac{1}{2 {μ}_{0} {A}_{1}} [ {λ ( {ϕ}_{M} - {ϕ}_{C} )}^{2} + {{λ}^{′} ( {ϕ}_{M} + {ϕ}_{L} )}^{2} - {( {ϕ}_{C} + {ϕ}_{L} )}^{2} ]$$

The above equation is further expanded and organized as follows:

$$\begin{matrix}F = \frac{1}{2 {μ}_{0} {A}_{1}} ( {ϕ}_{controllable} + {ϕ}_{non - controllable} ) \\ {ϕ}_{controllable} = ( λ - 1 ) {ϕ}_{C}^{2} - 2 ( {λϕ}_{M} + {ϕ}_{L} ) {ϕ}_{C} \\ {ϕ}_{non - controllable} = ( λ + {λ}^{′} ) {ϕ}_{M}^{2} + ( {λ}^{′} - 1 ) {ϕ}_{L}^{2} + 2 {λ}^{′} {ϕ}_{M} {ϕ}_{L}\end{matrix}$$

ϕ_{controllable} is the magnetic flux related to the control current 105, The dimensionless parameter λ of the design area is equal to 1, so that the magnetic resultant force of the thrust plate 121 can linearize the control magnetic flux. Based on the above assumptions, the magnetic flux ϕ_{non-controllable} that has nothing to do with the control current 105 can be further simplified to get:

$${ϕ}_{non - controllable} = {{λ}^{′} ( {ϕ}_{M} + {ϕ}_{L} )}^{2} + ( {ϕ}_{M} - {ϕ}_{L} ) ( {ϕ}_{M} + {ϕ}_{L} )$$

When the bias magnetic flux ϕ_{M} is designed under the magnetic saturation condition, it can be assumed that the magnetic flux near its operating point can be regarded as a constant. In other words, ϕ_{M}+ϕ_{L}≅ϕ_{M}≅ϕ_{M}−ϕ_{L} is satisfied. Under this condition, ϕ_{non-controllable} can be regarded as constant, and λ′ can be designed arbitrarily. Since ϕ_{M} is limited by material properties, when the area ratio λ′ of A₁ to A₃ is larger, the magnetic flux generated by the magnetic flux ϕ_{non-controllable} that is independent of the control current 105 is larger.

Assuming A=A₁=A₂, and ϕ_{M}+ϕ_{L}≅ϕ_{M}≅ϕ_{M}−ϕ_{L}=constant, then the resultant force on the thrust plate 121 can be expressed by the following equation:

$$\sum F = \frac{1}{{μ}_{0} A} [ \frac{( 1 + {λ}^{′} )}{2} {ϕ}_{M}^{2} - {ϕ}_{M} {ϕ}_{C} ] \qquad ( 1 )$$

Assume that the basic air gaps are all g. When the thrust plate 121 generates axial displacement x, the air gap length on the A₁ surface is g+x, and the air gap length on the A₂ surface is g-x. The first air gap magnetic resistance R₁ and the second air gap magnetic resistance R₂ are respectively expressed as follows:

$${R}_{1} = \frac{g + x}{{μ}_{0} A} ‵ {R}_{2} = \frac{g - x}{{μ}_{0} A}$$

Referring to FIGS. 12 and 13, assume that the number of turns of the electromagnetic coil 104 is N, the control current i_{c}, the third air gap reluctance R₃, the magnet reluctance R_{M}, and the variable reluctance R_{C}. The reluctance network is shown in FIG. 13. From the main magnetic flux loop of the control coil, the relationship between the control current i_{c} of the electromagnetic coil 104 and the control current magnetic flux ϕ_{C} can be obtained as follows:

$${ϕ}_{C} = \frac{{Ni}_{C}}{{R}_{1} + {R}_{2}} = \frac{{μ}_{0} AN}{2 g} {i}_{C}$$

Bringing into the aforementioned thrust plate magnetic force equation (1), and assuming that ϕ_{M}=BₛₐₜAₛₐₜ, where Bₛₐₜ is the saturation magnetic flux (considered as a constant), it can be obtained after organized:

$$\sum F = \frac{( 1 + {λ}^{′} ) {( {B}_{sat} {A}_{sat} )}^{2}}{2 {μ}_{0} A} - \frac{{B}_{sat} {A}_{sat} N}{2 g} {i}_{C}$$

By designing the air gap area A1 of the first air gap 103A of the coil magnetic flux to be equal to the air gap area A2 of the second air gap 103B, and designing the saturation magnetic flux ϕ_{M}=BₛₐₜAₛₐₜ on the main path of the permanent magnet magnetic flux, a linear relationship between the force on the thrust plate 121 and the control current 105 can be achieved, and when the control current 105 is not supplied, the thrust plate 121 bears an initial bias magnetic force. After the control current 105 is supplied, the force on the thrust plate 121 gradually decreases as the control current 105 increases, as shown in FIG. 14.

In summary, the present disclosure provides a composite axial active magnetic bearing using permanent magnets and electromagnets, which has the characteristics of using a single coil, unidirectional current, and can carry heavy loads in one direction without increasing the current output, meeting the linear control goal of controlling current proportional to the bearing capacity; in particular, the present disclosure has a magnetic barrier structure, which forces the permanent magnet magnetic flux to only pass through the air gap on the same side of the thrust plate, so that the leakage magnetic flux is small and negligible relative to the magnetic flux of the permanent magnet, Then the control flux path and the permanent magnet flux path are decoupled to achieve the goal of linear control, which is especially suitable for applications where the operating environment of the suspended spindle is subject to large axial forces.

Although the present disclosure has been disclosed as above in the form of embodiments, it is not intended to limit the disclosure. Anyone with ordinary knowledge in the technical field can make some changes and modifications without departing from the spirit and scope of the disclosure. and modifications, so the scope of protection of this disclosure shall be subject to the scope of the appended patent application.

What is claimed is:

1. An axial active magnetic bearing, fixed to a structural object and symmetric to a rotation axis, said axial active magnetic bearing comprising:
a rotating shaft, comprising a main shaft and a thrust plate, said main shaft coaxial with said rotation axis, and said thrust plate concentrically arranged on said main shaft;
a magnetic yoke, comprising a first side and a second side opposite to each other, said first side and said second side respectively provided on two axial sides of said thrust plate and not contacting said thrust plate, a corresponding end of said first side and said second side having a chamber, said chamber positioned on a radial outside of said thrust plate, said first side having a first air gap surface adjacent to said chamber, said second side having a second air gap adjacent to said chamber, a first air gap formed between said first air gap surface and said thrust plate, a second air gap formed between said air gap surface and said thrust plate, and the error in a projected area size of said first air gap and said second air gap along the direction of said rotation axis less than 5%;
a permanent magnet, provided on a surface of said magnetic yoke facing said thrust plate relative to said main shaft, said permanent magnet not contacting said thrust plate, a third air gap formed between said thrust plate and said permanent magnet, and a permanent magnet magnetic flux formed between said permanent magnet and said magnetic yoke;
a magnetic barrier structure, provided on said first side and positioned between said permanent magnet and said first air gap surface, said first side having a first distance of cross-section area parallel to said rotation axis, said magnetic barrier structure having a second distance of cross-section area parallel to said rotation axis, said second distance of cross-section area smaller than said first distance of cross-section area, said magnetic barrier structure positioned in a path of said permanent magnet magnetic flux, and permanent magnet magnetic flux passed through said magnetic barrier structure, said first air gap and said third air gap; and
an electromagnetic coil, provided in said chamber and not contacting said thrust plate, a control magnetic flux formed between said thrust plate and said magnetic yoke after control current flows in said electromagnet coil, and said control magnetic flux passed through said first air gap and said second air gap.

2. The axial active magnetic bearing according to claim 1, a projection range of said first air gap and a projection range of said second air gap along the direction of said rotation axis are completely or partially overlapped.

3. The axial active magnetic bearing according to claim 1, wherein said main shaft is a magnetic body, and said main shaft and said magnetic yoke are separated a first distance, allowing said main shaft not to contact said magnetic yoke.

4. The axial active magnetic bearing according to claim 1, wherein said structural object is a magnetic body, and said structural object and said thrust plate are separated a second distance, allowing said structural object not to contact said thrust plate.

5. The axial active magnetic bearing according to claim 1, wherein both said structural object and said main shaft are magnetic bodies, and said structural object and said main shaft are separated a third distance, allowing said structural object not to contact said main shaft.

6. The axial active magnetic bearing according to claim 1, wherein a magnetic plate with magnetic permeability is provided on a surface of said permanent magnet facing said thrust plate, allowing a magnetic field of said third air gap to be uniformly distributed.

7. The axial active magnetic bearing according to claim 1, wherein said magnetic barrier structure, said second air gap and said third air gap are all positioned in paths of a permanent magnet magnetic leakage flux generated from said permanent magnet magnetic flux and a control magnetic leakage flux generated from said control magnetic flux.

8. The axial active magnetic bearing according to claim 1, wherein said magnetic barrier structure is made of materials with a different magnetic permeability coefficient, including ferrite, to control magnetic flux.

9. The axial active magnetic bearing according to claim 1, wherein said a radial bearing is provided between said rotating shaft and said structural object, allowing said rotating shaft to maintain a radial relative position with said radial bearing and said structural object.
